(19) United States
(12) Patent Application Publication
(10) Pub. No.: US 2006/0042376 A1
(43) Pub. Date: Mar. 2, 2006

(54) Liquid level sensor

(75) Inventors: Thomas K. Reusche, Elbum, IL (US); Philip E. Chumbley, Aurora, IL (US)

Correspondence Address: MCANDREWS HELD & MALLOY, LTD, 500 WEST MADISON STREET, SUITE 3400, CHICAGO, IL, 60661, US

(73) Assignee: Allied Precision Industries, Inc.

(21) Appl. No.: 10/984,076

(22) Filed: Nov. 8, 2004

Related U.S. Application Data
(60) Provisional application No. 60/605,952, filed on Aug. 31, 2004.

(51) Int. Cl. G01F 23/00

(52) U.S. Cl. 73/304 C; 340/620

(57) ABSTRACT

A liquid level sensing system including a receptacle and a liquid level sensor. The receptacle includes a base integrally formed with lateral walls defining a cavity therebetween and configured to receive and retain a liquid. The liquid level sensor is positioned on the receptacle. The liquid level sensor determines the level of liquid within the receptacle based on a location of the liquid in relation to the liquid level sensor.

### RELATED APPLICATIONS

The present application relates to and claims priority from U.S. Provisional Application No. 60/605,952, entitled “Remote Liquid Level Sensor,” which was filed on Aug. 31, 2004, and is hereby incorporated by reference in its entirety.

### BACKGROUND OF THE INVENTION

Embodiments of the present invention generally relate to a liquid level sensor, and more particularly to a sensor that senses the level of liquid within a receptacle, such as a birdbath, water bottle, water trough, pet water bowl, or various other liquid containers.

Liquid-retaining receptacles are used for various applications. Examples, of liquid-retaining receptacles include bird baths, water bottles, water troughs, water towers, and the like. In each instance, the receptacles are used to maintain a certain amount of liquid therein.

Typically, one visually inspects a liquid-retaining receptacle to determine the amount of liquid contained therein. The intended purpose of the receptacle may be rendered moot if the receptacle is empty. For example, a bird cannot bathe in a bird bath without water, nor can an athlete drink from an empty sports bottle.

In many instances, one may overlook the fact that a receptacle is empty. Typically, one determines that the receptacle is empty only upon a visual examination, and may realize that he/she should have acted quicker to refill the receptacle. For example, a pet may go thirsty for an extended period of time due to the fact that its owner did not realize a watering bowl was empty.

Thus, a need exists for a system and method for determining the level of liquid within a liquid-retaining receptacle. Also, a need exists for a system and method of indicating that the receptacle is empty.

### SUMMARY OF THE INVENTION

Embodiments of the present invention provide a liquid level sensing system, including a receptacle and a liquid level sensor. The receptacle, which may be a bird bath, trough, bowl, bottle, or bucket, includes a base integrally formed with lateral walls defining a cavity therebetween and is configured to receive and retain a liquid. The liquid level sensor may include a capacitor positioned on the receptacle, wherein the liquid level sensor determines the level of liquid within the receptacle based on a location of the liquid in relation to the liquid level sensor. The liquid level sensor detects a change in capacitance of the capacitor resulting from a change in the relative volumes of liquid and air within said receptacle. Optionally, the liquid level sensor may be configured to transmit and receive at least one of sound and ultrasonic pulses into the receptacle in order to determine the volume of liquid within the receptacle.

The capacitor may be a capacitor strip that extends from the base to a top portion of the lateral walls. Further, the capacitor may be within the cavity. Also, the liquid level sensor may include a plurality of capacitors. In particular, the capacitor may include a plurality of capacitor pads aligned from the base to a top portion of the lateral walls.

The system may also include a level indicator in communication with the liquid level sensor. The liquid level sensor receives level signals from the liquid level sensor and emits a signal indicative of the level of liquid within the receptacle. The signal indicative of the level of liquid within the receptacle may be a visual signal, such as produced by a light emitting diode (LED), light bulb, floodlight, or the like, or audio signal, such as produced through a speaker.

The system may also include a receiver that is remote from the receptacle, wherein the liquid level sensor sends signals, which may be wirelessly transmitted, to the receiver regarding the level of liquid within the receptacle. Additionally, the system may also include a repeater, wherein the repeater receives the signals from the liquid level sensor, and the repeater transmits the signals to the receiver.

Embodiments of the present invention also provide a method of sensing a level of a liquid within a receptacle configured to receive and retain the liquid. The method includes positioning a liquid level sensor on the receptacle, and determining the level of liquid within the receptacle based on a location of the liquid in relation to the liquid level sensor.

Embodiments of the present invention also provide a system for sensing a level of a substance contained within a receptacle. The system includes a level sensor having a capacitor. The level sensor is configured to be either permanently or removably secureable to the receptacle, and determine the level of substance within the receptacle based on a location of the substance in relation to the level sensor. The level sensor is configured to detect a change in capacitance of the capacitor resulting from a change in the relative volumes of the substance and air within the receptacle.

### BRIEF DESCRIPTION OF SEVERAL VIEWS OF THE DRAWINGS

FIG. 1 illustrates a schematic representation of a level sensing system, according to an embodiment of the present invention.

FIG. 1a illustrates a schematic representation of the sensing unit, according to an embodiment of the present invention.

FIG. 1b illustrates a simplified circuit diagram of a level sensing circuit, according to an embodiment of the present invention.

FIG. 2 illustrates an isometric view of a liquid receptacle, according to an embodiment of the present invention.

FIG. 3 illustrates a transverse cross-sectional view of a liquid receptacle, according to an embodiment of present invention.

FIG. 4 illustrates a capacitor strip, according to an embodiment of the present invention.

FIG. 5 illustrates a capacitor strip configuration, according to an embodiment of the present invention.

FIG. 6 illustrates a capacitor pad configuration, according to an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

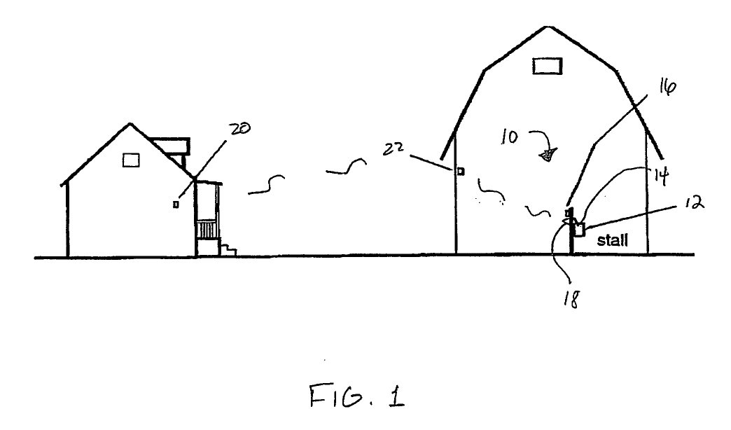

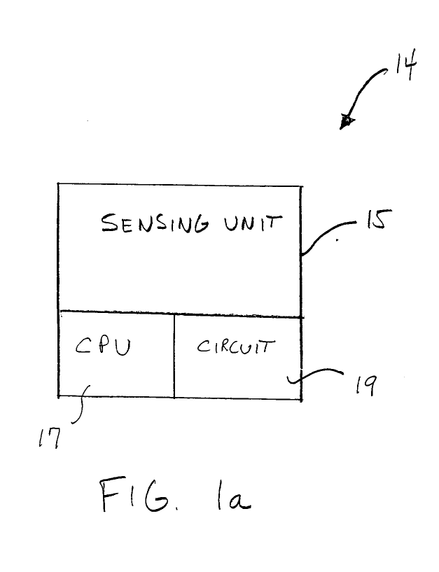

FIG. 1 illustrates a schematic representation of a level sensing system 10, according to an embodiment of the present invention. The system 10 includes receptacle 12, for receiving and retaining a liquid such as water, operatively connected to a sensing unit 14, which includes a processor operatively a level sensing circuit (shown in FIG. 7). The receptacle 12 may be a bird bath, a livestock or pet water trough or bucket, a precipitation measuring receptacle, or various other devices configured to receive and retain a liquid. The sensing unit 14 may be in electrical communication with a level indicator 16 that is configured to emit a signal indicative of a liquid level. The level indicator 16 may be a light emitting diode (LED), light bulb, speaker, or any other such device that transmits a visual or auditory signal.

FIG. 1a illustrates a schematic representation of the sensing unit 14, according to an embodiment of the present invention. The sensing unit 14 includes a main body 15 housing a processor 17 operatively connected to a level sensing circuit 19, which may include a capacitor or sound or ultrasound emitting device, as discussed below.

When the liquid level is lower than a predetermined point within the receptacle 12, the sensing unit 14 sends a low liquid level signal to the level indicator 16 through a wired or wireless connection. Optionally, the sensing unit 14 may send various liquid level signals to the level indicator 16. For example, the sensing unit 14 may send a full level signal to the level indicator 16 when the receptacle 12 is filled with liquid. The level indicator 16 may then emit a signal (such as a visual or auditory signal) that indicates that the receptacle 12 is full. The sensing unit 14 may send various signals, ranging from empty to full, to the level indicator 16, which may, in turn, emit signals that correspond to the level of liquid in the receptacle 12.

The system 10 may also include a transmitter 18 configured to transmit signals received from the sensing unit 12 to a receiver 20, or a repeater 22, which in turn sends the signals to the receiver 20. The transmitter 18 and the sensing unit 14 may be contained within a single housing. Optionally, the transmitter 18 may be remote from the sensing unit 14. The receiver 20 includes a processing unit (not shown) and receives the signals. The receiver may then display information relating to the received signals on a display unit, such as an integrated monitor or external computer monitor, that indicate the liquid level in the receptacle 12.

FIG. 2 illustrates an isometric view of the liquid receptacle 12, according to an embodiment of the present invention. The receptacle 12 includes a non-metallic main body defined by a base 24, lateral walls 26 and an inner cavity 28 defined between the base 24 and the lateral walls 26. While the receptacle 12 is shown as a cylindrical bucket, the receptacle 12 may be any type of structure configured to receive and retain liquid, such as a bird bath, livestock or pet water bowl or trough, water bottle, or the like.

The sensing unit 14 is attached to the outside of the receptacle 12, and is configured to sense the presence of liquid proximate to its position. The sensing unit 14 may be removably secured to the receptacle 12. For example, the sensing unit 14 may be configured to snapably or latchably engage a corresponding structure on the receptacle 12. Alternatively, the sensing unit 14 may be secured to the receptacle through rubber bands, Velcro, string, rope, or various other methods of attachment. Also, alternatively, the sensing unit 14 may be permanently affixed to the receptacle 12 through glue, fasteners, such as screws, nail, or the like, or may be bonded to the receptacle 12.

A user may secure the sensing unit 14 to the receptacle 12 at a desired level. That is, a low level position may be determined and the sensing unit 14 may be secured to the receptacle proximate the low level position. Once a substance, such as water, recedes below the low level position, the sensing unit 14 senses a change in level, as described below. For example, the sensing unit 14 may determine a first capacitance when water is at or above the low level position, and a second capacitance when water is below the low level position. The sensing unit 14 may be positioned at any level on the receptacle 12 that a user deems appropriate. Additionally, multiple sensing units 14 may be positioned at different levels to provide information at various levels. For example, one sensing unit 14 may be secured at a low level position, while a second sensing unit 14 may be positioned at a half-full position.

While the sensing unit 14 is shown on the outside of the receptacle 12, the sensing unit 14 may alternatively be appropriately insulated and disposed within the cavity 28. The sensing unit 14 includes a capacitor that is configured to measure the capacitance of the receptacle 12. A measure of the capacitance of the capacitor positioned on the receptacle 12 allows the sensing unit 14 to determine the level of liquid contained within the receptacle 12. The capacitor may be a pad on the side of the sensing unit 14, or optionally may be a plurality of pads arranged in a vertical line to detect liquid levels at distinct points.

The capacitance of a parallel-plate capacitor whose plates are separated by air is determined by equation (1) set forth below:
C=kε₀(A/d) (1)
where A is the area of one of the plates, d is the distance of separation of the plates and ε₀ is a constant known as the permittivity of free space, which has a value of 8.85×10⁻¹² farads/meter.

The dielectric constant k depends upon the material adjacent the capacitor. For instance, air has a dielectric constant of 1, glass has a dielectric constant of 4.5, while polystyrene plastic has a dielectric constant of 2.6. The dielectric constant of water is 78. Thus, the capacitance changes by a factor of 78 for a plate capacitor, depending on whether air or water is the dielectric material. Such change in capacitance provides a determination as to whether water or air is contained in a receptacle on which the capacitor is mounted.

The relationship between capacitance, charge and voltage is given by equation (2), set forth below:
q=CV (2)
where q is the charge on the capacitor and V is the voltage across the terminals. A change in capacitance is seen as a change in charge for a given voltage when the dielectric material changes.

FIG. 1b illustrates a simplified circuit diagram 29 of a level sensing circuit, according to an embodiment of the present invention. The level sensing circuit 19 shown in FIG. 1a may include the circuit shown in FIG. 1b. In order to observe the change in capacitance, one may connect a capacitor 31 in series with a resistor 33 to form an RC circuit. Connecting the circuit to a battery 35 causes current to flow through the resistor 33 and charge the capacitor 31. The rate at which the charge on the capacitor 31 increases is given by equation (3):
q=CV₀(1−e^{-1/RC}) (3)
where q is once again the charge, V₀ is the battery voltage, R is the resistance of the resistor, and C is the capacitance of the capacitor. The value RC is called the time constant of the circuit. Because, V=q/C, the voltage V_{C} across the capacitor is given by equation (4) set forth below:
V_{C}=V₀(1−e^{-1/RC}) (4)
Thus, the voltage across the capacitor increases exponentially as a function of time. By replacing C in the equation (4) with a higher value, such as would occur with an increase in the dielectric constant, the time constant RC changes accordingly, and the capacitor therefore takes longer to charge. The change in the time constant is directly proportional to the change in capacitance.

Referring again to FIG. 2, the sensing unit 14 includes a level sensing circuit, such as circuit 29 shown in FIG. 1b, and is configured to detect changes in capacitance of the receptacle 12 by detecting the change in time constant. That is, as the water is removed from the receptacle 12, the time constant changes, and therefore the capacitor charges in a shorter period of time than if the level sensing circuit of the sensing unit 14 was adjacent water. Again, the dielectric constant of water is higher than that of air. Thus, as water is drained, siphoned, or otherwise removed from the receptacle 12, the sensing unit 14 detects a change in capacitance, i.e., the change in capacitance due to the sensing unit 14 sensing the capacitance of an air-filled receptacle 12, as opposed to a water-filled receptacle 12. When the water recedes below line 30, which is underneath the sensing unit 14, the sensing unit 14 detects a capacitance that relates to air, instead of water. The sensing unit 14 may then send a signal to the level indicator 16 (shown in FIG. 1), or directly to the receiver 20 (shown in FIG. 1), that the liquid level within the receptacle 12 is low.

Alternatively, the sensing unit 14 may include a sonar or ultrasonic unit that is integrally formed with the sensing unit 14. The sonar or ultrasonic unit is configured to transmit and receive sound or ultrasonic pulses into the cavity and reflect off liquid, or another substance, contained therein. The sensing unit 14 may then measure the length of time the sound or ultrasonic pulses take to travel back to the sensing unit 14. For a liquid, it is possible to transmit the pulses through the non-metallic walls of the receptacle 12, into the liquid, and monitor the reflection of the sound or ultrasonic pulses.

The time (t) for a pulse to travel the depth of the liquid is determined by dividing the time lapse (Δt) between the transmission of the pulse and its reception back at the detector by two (2). Then, by knowing the speed of sound (v_{L}) in the liquid, the depth of the liquid (y) in the container may be calculated by dividing the time it takes for the pulse to travel the liquid surface by the speed of sound in the liquid. As such, the depth of the liquid is given by equation (5) set forth below:
y=t/v_{L} (5)
Thus, the amount of liquid within the receptacle 12 may be determined through the sensing unit 14 emitting and receiving sound or ultrasonic pulses within the cavity 28.

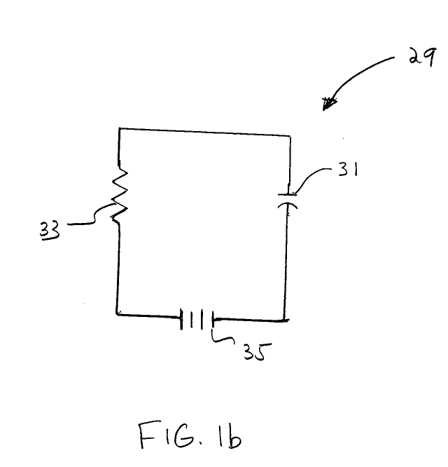

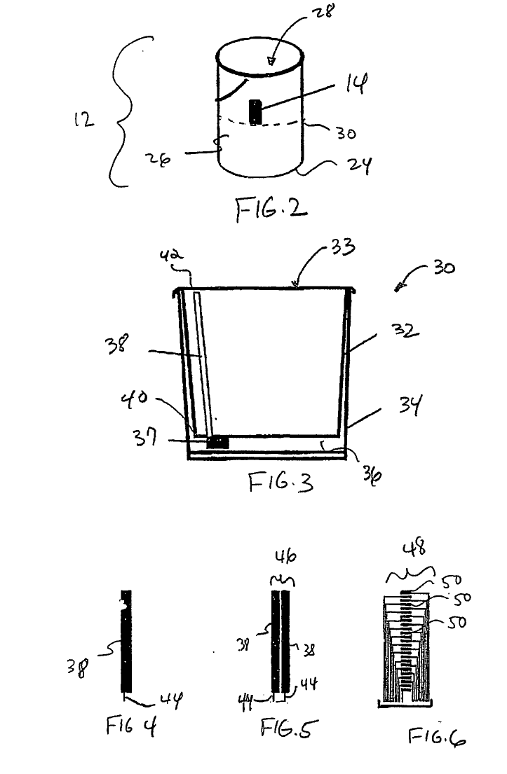

FIG. 3 illustrates a transverse cross-sectional view of a liquid receptacle 30, according to an embodiment of present invention. The receptacle 30 includes an inner bucket 32, defining a liquid-retaining cavity 33 therein, connected to an outer bucket 34 at upper edges thereof, so that an inner space 36 is defined therebetween. A sensing unit 37 is positioned within the inner space 36 and is operatively connected to a capacitor strip 38 that extends from the bottom 40 to the top 42 of the inner bucket 32.

Because the capacitor strip 38 extends the entire height of the inner bucket 32 (and therefore the inner liquid-retaining cavity 33), the capacitor strip 38 may detect changes in capacitance over the entire depth of the liquid-retaining cavity 33. The sensing unit 37 receives signals from the capacitor strip 38, and may then detect the level of liquid within the liquid-retaining cavity 33 based on changes in capacitance. For example, if the liquid-retaining cavity 33 is empty, the sensing unit 37 detects a first capacitance through the capacitor strip 38. If the liquid-retaining cavity 33 is half-full, the sensing unit 37 detects a second capacitance through the capacitor strip 38. If the liquid-retaining cavity is completely full, the sensing unit 37 detects a third capacitance through the capacitor strip 38. While the sensing unit 37 and the capacitor strip 38 are shown within the inner space 40, each may alternatively be disposed within the cavity 33, or even on the outside of the outer bucket 34. Further, the sensing unit 37 and capacitor strip 38 may be used with the receptacle 12 shown in FIG. 2, instead of the sensing unit 14.

The capacitor may be a capacitor strip, such as capacitor strip 38, or may optionally be shaped or oriented in various different ways. For example, the capacitor may be a sheet that is wrapped around the receptacle 12.

FIG. 4 illustrates the capacitor strip 38. The capacitor strip 38 is connected to an electrical lead 44, that is configured to be electrically connected to a sensing unit. The capacitor strip 38 is a single, unitary capacitor.

FIG. 5 illustrates a capacitor strip configuration 46, according to an embodiment of the present invention. The configuration 46 includes two capacitors strips 38 having leads 44 that are configured to be electrically connected to a sensing unit. The use of two capacitor strips 38 provides a check against an erroneous reading. For example, one of the strips 38 may be damaged, or detecting a faulty reading due to debris or water droplets adhering thereto. The second strip 38 provides a check against such situations. Further, additional strips 38 may be used, as well. Additional strips 38 may be mounted at different locations on the receptacle and sense levels at those locations, thereby accurately determining volumes even if the receptacle is tilted.

FIG. 6 illustrates a capacitor pad configuration 48, according to an embodiment of the present invention. The configuration 48 includes a plurality of individual capacitor pads 50 oriented in a vertical line that extends from the bottom liquid retaining surface of a receptacle, to a top surface thereof. A sensing unit detects capacitance readings from each individual pad 50, and may determine the level of liquid within a receptacle based on the capacitance readings of each individual pad 50.

While embodiments of the present invention are generally related to sensing liquid levels, they may also be used to detect levels of various non-liquid materials, such as gels and dense solids. Additionally, processors within the sensing units or receivers may be configured to keep tracks of liquid level readings, and therefore determine the volume of water that has been consumed or otherwise used.

Thus, embodiments of the present invention provide a reliable and efficient system and method for measuring the level of liquid within a liquid-retaining receptacle. Embodiments of the present invention also provide a system and method of indicating the level of liquid within the receptacle.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A liquid level sensing system, comprising:
a receptacle comprising a base integrally formed with lateral walls defining a cavity therebetween and configured to receive and retain a liquid, and
a liquid level sensor positioned on said receptacle, wherein said liquid level sensor determines the level of liquid within said receptacle based on a location of the liquid in relation to said liquid level sensor.

2. The system of claim 1, wherein said liquid level sensor comprises a capacitor, wherein said liquid level sensor detects a change in capacitance of said capacitor.

3. The system of claim 2, wherein the change in capacitance results from a change in the relative volumes of liquid and air within said receptacle.

4. The system of claim 2, wherein said capacitor is a capacitor strip that extends from said base to a top portion of said lateral walls.

5. The system of claim 4, wherein said capacitor strip is within said cavity.

6. The system of claim 4, comprising a plurality of capacitor strips.

7. The system of claim 2, wherein said capacitor comprises a plurality of capacitor pads aligned from said base to a top portion of said lateral walls.

8. The system of claim 1, wherein said liquid level sensor is configured to transmit and receive at least one of sound and ultrasonic pulses into said receptacle in order to determine the volume of liquid within said receptacle.

9. The system of claim 1, further comprising a level indicator in communication with said liquid level sensor, said liquid level sensor receiving level signals from said liquid level sensor and emitting a signal indicative of the level of liquid within said receptacle.

10. The system of claim 9, wherein said signal indicative of the level of liquid within said receptacle is at least one of a visual and audio signal.

11. The system of claim 1, further comprising a receiver that is remote from said receptacle, wherein said liquid level sensor sends signals to said receiver regarding the level of liquid within said receptacle.

12. The system of claim 11, wherein said liquid level sensor sends wireless signals to said receiver.

13. The system of claim 11, further comprising a repeater, wherein said repeater receives the signals from said liquid level sensor, and said repeater transmits the signals to said receiver.

14. The system of claim 1, wherein said receptacle is a birdbath.

15. The system of claim 1, wherein said receptacle is one of a trough, bowl, bottle, and bucket.

16. A method of sensing a level of a liquid within a receptacle configured to receive and retain the liquid, the method comprising:
positioning a liquid level sensor on the receptacle; and
determining the level of liquid within the receptacle based on a location of the liquid in relation to the liquid level sensor.

17. The method of claim 16, wherein said determining comprises detecting a capacitance of a capacitor of the liquid level sensor.

18. The method of claim 17, wherein said detecting comprises detecting a change in capacitance resulting from a change in the relative volumes of liquid and air within the receptacle.

19. The method of claim 16, wherein said determining comprises transmitting and receiving at least one of sound and ultrasonic pulses into the receptacle in order to determine the volume of liquid within the receptacle.

20. The method of claim 16, further comprising sending a signal from the liquid level sensor to a level indicator; and emitting a signal indicative of the level of liquid within the receptacle.

21. The method of claim 20, wherein said sending comprises sending at least one of a visual and audio signal.

22. The method of claim 16, further comprising sending signals to a remote receiver regarding the level of liquid within the receptacle.

23. The method of claim 22, wherein said sending signals to the remote receiver comprises wirelessly sending signals to the remote receiver.

24. A level sensing system, comprising:
a receptacle comprising a base integrally formed with lateral walls defining a cavity therebetween and configured to receive and retain a substance, and
a level sensor comprising a capacitor positioned on said receptacle, wherein said level sensor determines the level of substance within said receptacle based on a location of the substance in relation to said level sensor, wherein said level sensor detects a change in capacitance of said capacitor resulting from a change in the relative volumes of the substance and air within said receptacle.

25. The system of claim 24, wherein said capacitor is a capacitor strip that extends from said base to a top portion of said lateral walls.

26. The system of claim 24, wherein said capacitor is within said cavity.

27. The system of claim 24, comprising a plurality of capacitors positioned on said receptacle.

28. The system of claim 24, wherein said capacitor comprises a plurality of capacitor pads aligned from said base to a top portion of said lateral walls.

29. The system of claim 24, further comprising a level indicator in communication with said level sensor, said level sensor receiving level signals from said level sensor and emitting a signal indicative of the level of the substance within said receptacle.

30. The system of claim 29, wherein said signal indicative of the level of substance within said receptacle is at least one of a visual and audio signal.

31. The system of claim 24, further comprising a receiver that is remote from said receptacle, wherein said level sensor sends signals to said receiver regarding the level of substance within said receptacle.

32. The system of claim 31, wherein said level sensor sends wireless signals to said receiver.

33. The system of claim 31, further comprising a repeater, wherein said repeater receives the signals from said level sensor, and said repeater transmits the signals to said receiver.

34. The system of claim 24, wherein said receptacle is a birdbath.

35. The system of claim 24, wherein said receptacle is one of a trough, bowl, bottle, and bucket.

36. A system for sensing a level of a substance contained within a receptacle, comprising:
a level sensor comprising a capacitor, said level sensor being configured to be secureable to the receptacle, and said level sensor configured to determine the level of substance within the receptacle based on a location of the substance in relation to said level sensor, said level sensor being configured to detect a change in capacitance of said capacitor resulting from a change in the relative volumes of the substance and air within said receptacle.

37. The system of claim 36, wherein said level sensor is removably secureable to the receptacle.

38. The system of claim 36, wherein said level sensor is securable to the a low level position of the receptacle.

39. The system of claim 36, further comprising a plurality of level sensors.

40. The system of claim 36, wherein said capacitor is a capacitor strip that is configured to extend from a base of the receptacle to a top portion of the receptacle.

41. The system of claim 36, further comprising a level indicator in communication with said level sensor, said level sensor configured to receive level signals from said level sensor and emit a signal indicative of the level of substance within said receptacle.

42. The system of claim 41, wherein said signal indicative of the level of the substance within said receptacle is at least one of a visual and audio signal.

43. The system of claim 36, wherein the receptacle is a birdbath.

44. The system of claim 36, wherein the receptacle is one of a trough, bowl, bottle, and bucket.
